(19) United States
(12) Patent Application Publication
(10) Pub. No.: US 2002/0106944 A1
(43) Pub. Date: Aug. 8, 2002

(54) Electric contact and electronic device

(75) Inventors: Yoshinobu Miyanoo, Shinagawa (JP); Kazuo Youda, Shinagawa (JP)

Correspondence Address: STAAS & HALSEY LLP, 700 11TH STREET, NW, SUITE 500, WASHINGTON, DC, 20001, US

(73) Assignee: FUJITSU COMPONENT LIMITED, Tokyo (JP)

(21) Appl. No.: 09/988,158

(22) Filed: Nov. 19, 2001

(30) Foreign Application Priority Data
Feb. 6, 2001 (JP) 2001-29822

(51) Int. Cl. H01R 9/24; H01R 13/02

(52) U.S. Cl. 439/886

(57) ABSTRACT

An electric contact for making an electrical conduction by metal contact, includes a metal base, a nickel layer stacked on the metal base, a gold layer forming an outer portion of the electric contact, and a gold-nickel alloy layer disposed between the nickel layer and the gold layer.

### BACKGROUND OF THE INVENTION

1. Field of the Invention

The present invention generally relates to electric contacts and electronic devices such as connectors, and more particularly, to an electric contact used for a switch part or a connector part for an electronic equipment and an electronic device such as a connector.

2. Description of the Related Art

Electric contacts for achieving electrical conduction by contacting metal are used for a switch part, a connector part which is used as a connection part for an electronic equipment, or the like. The switch part includes a relay, a mechanical switch for a lead switch and a key board, or the like.

When using the electric contact for the switch part, it is required that the electric contact has both an electrical property such as a high conductivity and a mechanical property such as a resistance to corrosion and a resistance to frictional wear against repeated contacting action, in order to maintain a high reliability for a long period of time.

When using the electric contact for the connector part, it is required that the connector has not only an electrical property and a mechanical property such as the resistance to corrosion and the resistance to frictional wear as described above, but also a high ability to make sliding contact. If the connector has the high ability to make sliding contact, only a small force is required to insert and extract the connector with respect to another connector or part.

Generally, a noble metal, a metal having a high melting point, a simple element such as copper and graphite, or an alloy thereof, is used as it is, as a material forming the electric contact. For instance, gold, silver, platinum, and rhodium are included in the noble metal. Also, for instance, tungsten and molybdenum are included in the metal having the high melting point. Alternatively, the above-mentioned metals may be stacked on a metal base by plating to form the electric contact.

Particularly, a double layer structure or a triple layer structure may be used for the electric contact of the connector. The double layer structure has, as shown in FIG. 1, for instance, a plated nickel layer 2 having a thickness of approximately 1.0 μm stacked on a metal base 1 made of a copper alloy, and a plated gold layer 3 having a thickness of approximately 0.65 μm on the plated nickel layer 2. The triple layer structure has, as shown in FIG. 2, for instance, a plated nickel layer 2 having a thickness of approximately 1.0 μm stacked on a metal base 1, a plated palladium-nickel alloy layer 4 having a thickness of approximately 0.5 μm stacked on the plated nickel layer 2, and a plated gold layer 3 having a thickness of approximately 0.05 μm thickness stacked on the plated palladium-nickel alloy layer 4. A pin hole 5 is generated in each layer at the time of forming each layer in the double layer structure or the triple layer structure.

The double layer structure made of the plated nickel layer 2 and the plated gold layer 3 has advantages in that it has a good electrical property, high resistance to corrosion, and high ability to make sliding contact because the plated gold layer 3 is provided as the top layer, and high resistance to frictional wear because of the provision of the plated nickel layer 2. However, the double layer structure has disadvantages in that the pin hole 5 is apt to occur in the double layer structure. The pin hole 5 in the double layer structure penetrates the plated nickel layer 2 and the plated gold layer 3 and reaches the metal base 1 as shown in FIG. 1. The generation of the pin hole 5 deteriorates the resistance to corrosion of the electric contact. Furthermore, generally, the pin hole 5 deteriorates the ability to make sliding contact when the plated gold layer 3 is thick, because gold is a soft material.

In order to solve the above-mentioned disadvantages, gold-cobalt alloy plating may be used for maintaining a hardness of the electric contact. However, in this case, there is a limit to increase a cobalt content in the plated gold-cobalt alloy layer due to a deposition requirement such as a limitation of amount of cobalt melting in a bath for plating. Hence, there is a limit to improve the hardness of the electric contact.

On the other hand, the triple layer structure comprises the plated nickel layer 2, the plated palladium-nickel alloy layer 4, and the plated gold layer 3. The plated palladium-nickel alloy layer 4 has a high resistance to corrosion. Besides, it is possible to form a thin plated gold layer 3 because the plated palladium-nickel alloy layer 4 is formed. Hence, the triple layer structure can have a high ability to make sliding contact because of the provision of the plated gold layer 3 which is thin. Furthermore, as shown in FIG. 2, in this case, the pin hole 5, penetrating the respective plating layers and reaching the metal base 1, is less likely to be generated as compared to the double layer structure. Hence, the above-mentioned triple layer structure has an advantage in that the electric contact having the triple layer structure can maintain the high resistance to corrosion of the electric contact.

Therefore, in terms of a function of the electric contact of the connector, the triple layer structure, comprising the plated nickel layer 2, the plated palladium-nickel alloy layer 4, and the plated gold layer 3, is more preferable than the double layer structure comprising the plated nickel layer 2 and the plated gold layer 3.

Meanwhile, the noble metal such as gold and palladium is expensive and the price thereof greatly fluctuates in the market.

Up to now, the triple layer structure had more advantage as to the manufacturing cost than the double layer structure, because gold was expensive. However, recently, the cost of palladium is higher than the cost of gold. Therefore, the manufacturing cost for the double layer structure is almost same as that for the triple layer structure. As a result, when gold or palladium is used as a main material for plating layer, the manufacturing cost becomes high.

### SUMMARY OF THE INVENTION

Accordingly, it is a general object of the present invention is to provide a novel and useful electric contact and electronic device such as a connector in which one or more of the problems described above are eliminated.

Another and more specific object of the present invention is to provide an electric contact and an electronic device such as a connector which have and carry out a functionally required electrical property and mechanical property such as a resistance to corrosion, a resistance to wear or an ability to make sliding contact and which can be manufactured with a low cost.

Still another object of the present invention is to provide an electric contact for making an electrical conduction by metal contact, includes a metal base, a nickel layer stacked on the metal base, a gold layer forming an outer portion of the electric contact, and a gold-nickel alloy layer disposed between the nickel layer and the gold layer.

The gold-nickel alloy layer may include 75 to 95 mass percent gold and 5 to 25 mass percent nickel.

The nickel layer may have a thickness of 0.5 to 5 μm, the gold-nickel alloy layer may have a thickness of 0.1 to 2 μm, and the gold layer may have a thickness of 0.03 to 0.3 μm.

The nickel layer, the gold-nickel alloy layer and the gold layer may be formed by plating.

According to the above invention, it is possible to obtain an electric contact which has and carries out a functionally required electrical property and a mechanical property such as a resistance to corrosion, a resistance to frictional wear or an ability to make sliding contact. Also, the electric contact of the present invention can be manufactured with a low manufacturing cost.

A further object of the present invention is to provide a connector, including an electric contact for making an electrical conduction by metal contact, the electric contact including a metal base, a nickel layer stacked on the metal base, a gold layer forming an outer portion of the electric contact, and a gold-nickel alloy layer disposed between the nickel layer and the gold layer.

According to the above invention, it is possible to obtain a connector which has above-mentioned advantages and whose force to insert and extract is little at the time of being inserted and extracted.

A further object of the present invention is also to provide an electronic device, including an electric contact for making an electrical conduction by metal contact, the electric contact including a metal base, a nickel layer stacked on the metal base, a gold layer forming an outer portion of the electric contact, and a gold-nickel alloy layer disposed between the nickel layer and the gold layer.

Other objects, features, and advantages of the present invention will be more apparent from the following detailed description when read in conjunction with the accompanying drawings.

### BRIEF DESCRIPTION OF THE DRAWINGS

FIG. 1 is a cross-sectional view explaining a conventional double plating layer formed on an electric contact of a connector;

FIG. 2 is a cross-sectional view explaining a conventional triple plating layer formed on an electric contact of a connector;

FIG. 3 is a perspective view of two connectors and a board connected with the connector in an embodiment of the present invention;

FIG. 4 is a cross-sectional view taken along a line A in Y1-Y2 direction, viewed in a direction XI, and explaining a state where the connectors shown in FIG. 3 are connected to each other;

FIG. 5 is an enlarged perspective view showing a portion of an electric contact of the connector shown in FIG. 3; and

FIG. 6 is a cross-sectional view explaining a plated layer formed on an electric contact of a connector.

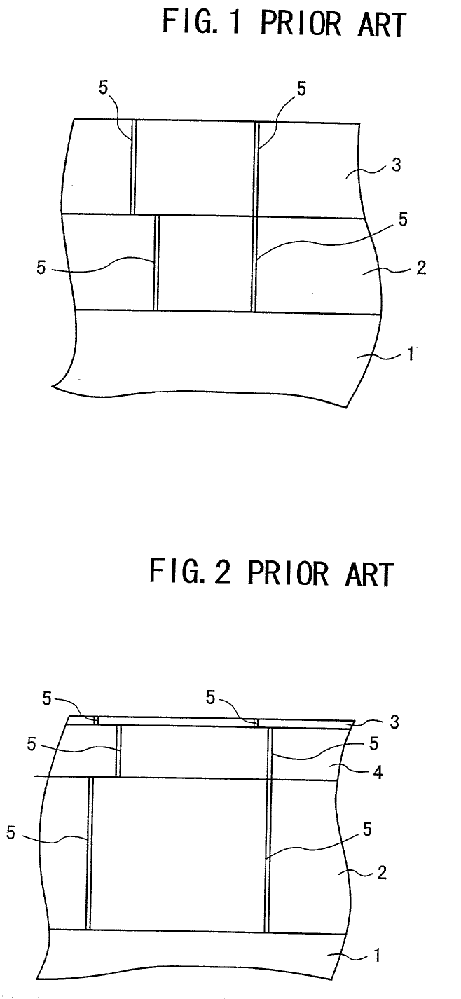

### DETAIL DESCRIPTION OF THE PREFERRED EMBODIMENTS

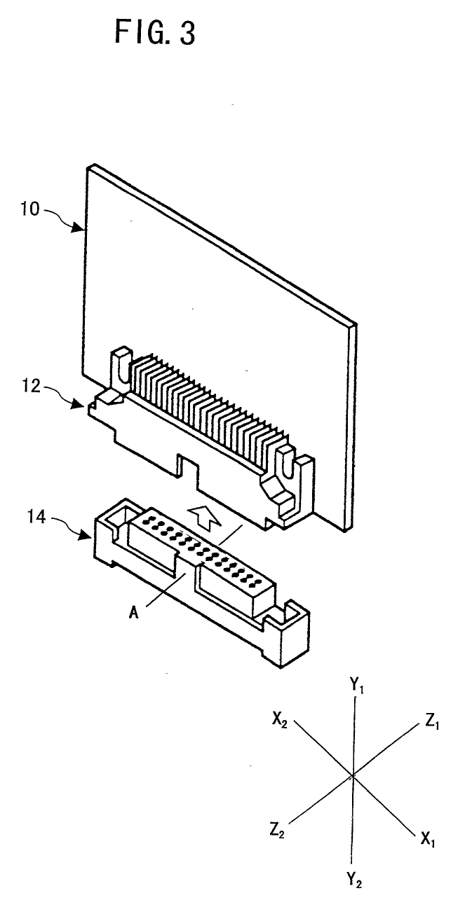

A description regarding embodiments of an electric contact and a connector according to the present invention will now be given, with reference of FIGS. 3 to 6.

Referring to FIGS. 3 to 5, the embodiment of a connector having an electric contact according to the present invention, will be explained.

The connecter is used for connecting a board such as a wiring board and another board. FIG. 3 is a perspective view of two connectors and a board connected to the connector in this embodiment of the present invention. A connector 12 provided on a board 10 and a connector 14 are shown in FIG. 3. A board connected to the connector 14 is not shown in FIG. 3.

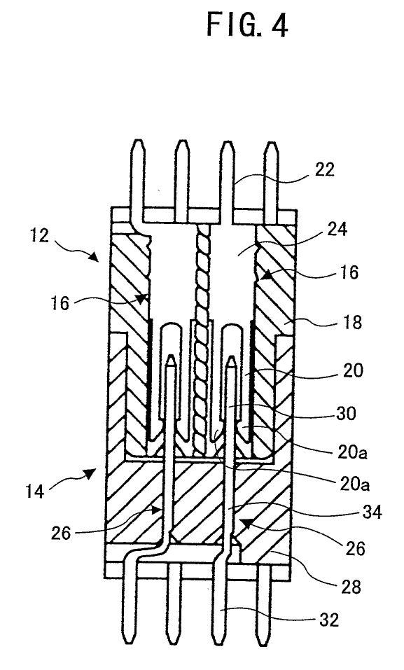

FIG. 4 is a cross-sectional view taken along a line A in Y1-Y2 direction, viewed in a direction X1, and explaining a state where the connectors shown in FIG. 3 are connected to each other

In the connector 12, two rows of electric contacts 16 called fork-contacts are arranged in an insulator 18. The electric contact 16 includes a first electric contact part 20, a second electric contact part 22, and a connection part 24. The first electric contact part 20 and the second electric contact part 22 are connected by the connection part 24. The first electric contact part 20 has a fork shape. The second electric contact part 22 has a narrow plate shape. The connection part 24 has a wide plate shape. The first electric contact part 20 and the connection part 24 are press-fit into the insulator 18, so that the contact 16 is fixed. Projection parts 20a are formed in the first electric contact part 20 as respectively facing an inside of a head end part of the first electric contact part 20. The first electric contact part 20 is connected with a third electric contact part 30 of the connector 14 as the first electric contact part 20 can be connected and disconnected to the third electric contact part 30 easily. A second electric contact part 22 is connected to the board 10.

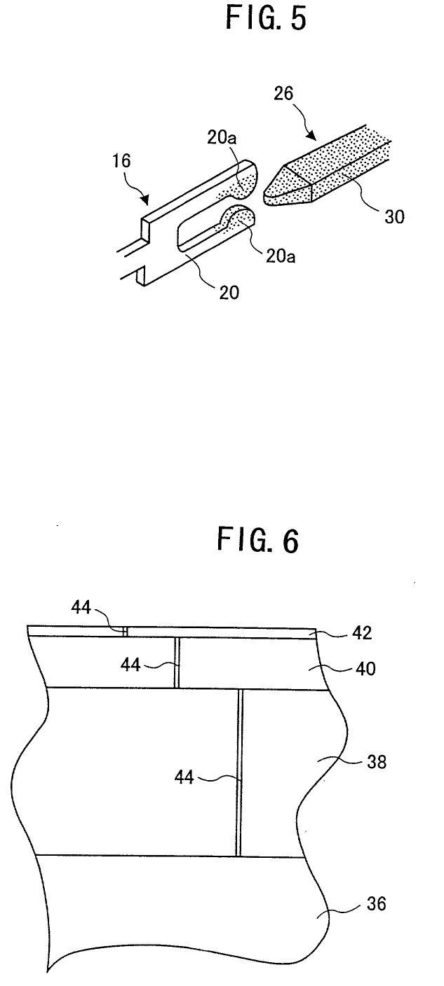

The electric contact 16 is formed in a state where a copper alloy material is used as a metal base. The surface portion of the projection part 20a of the first electric contact part 20 and vicinities of the projection part 20a, indicated by dots in FIG. 5, have a triple layer structure. It is desirable that at least a portion of the first electric contact part 20 which makes sliding contact with a corresponding the third electric contact part 30 has the triple layer structure.

In the connector 14, two rows of electric contacts 26 called knife-contacts are arranged in an insulator 28, as the two rows of electric contacts 16 are arranged in the insulator 18. The electric contact 26 has a substantially pin shape. The third electric contact part 30 and the fourth electric contact part 32 are connected by the connection part 34. The fourth electric contact part 32 has an L-shape. The connection part 34 is press-fit and fixed into the insulator 28. The third electric contact part 30, as described above, is connected to the first electric contact part 20 as the third electric contact part 30 can be connected and disconnected the first electric contact part 20 easily. The fourth electric contact part 32 is connected to a board not shown in FIG. 4.

The electric contact 26 is formed in a state where a copper alloy material is used as a metal base. The surface portion of the third electric contact part 30 indicated by dots in FIG. 5, has a triple layer structure. It is desirable that at least a portion of the third electric contact part 30 which makes sliding contact with a corresponding the first electric contact part 20 has the triple layer structure.

When the connector 12 and the connector 14 are connected to each other, the insulator 18 and the insulator 28 are clamped and connected to each other. In this case, the third electric contact part 30 of the electric contact 26 is clamped and connected with the first electric contact part 20 of the electric contact 16 by sliding through between the respective projection parts 20a. Hence, it is possible to make electrical connection between the connector 12 and the connector 14.

When the connectors 12 and 14 are disconnected from each other, an operation which is reverse to that described above, is carried out.

Next, referring to FIG. 6, the plated layers in the triple layer structure as to the electric contacts 16 and 26, will be explained. FIG. 6 is a cross-sectional view explaining a plated layer formed on an electric contact of the connector.

The plated layers in the triple layer structure as to the electric contacts 16 and 26 are formed on a metal base 36 made of the copper alloy. In the structure, a nickel layer 38 having a thickness of approximately 1.00 μm is formed on the metal base 36, and a gold-nickel alloy layer 40 having a thickness of approximately 0.3 μm is formed on the nickel layer 38. A gold layer 42 having a thickness of approximately 0.05 μm is formed as a top layer, namely an outer portion or an outer peripheral surface of the electric contact.

A composition of the gold-nickel alloy layer 40 comprises 80 mass percent gold and 20 mass percent nickel.

The respective plated layers 38, 40, and 42 are formed by plating.

The electric contact 16 of the connector 12 and the electric contact 26 of the connector 14 can have mechanical properties such as a high resistance to frictional wear, because of the provision of the nickel layer 38.

The electric contact 16 of the connector 12 and the electric contact 26 of the connector 14 can also have the above-mentioned mechanical properties included by the nickel material, the high electrical properties and the resistance to corrosion included by the gold material, because of the provision of the gold-nickel alloy layer 40. For instance, the gold-nickel alloy layer 40 has a hardness of approximately 180HK which is higher than a hardness of the gold layer of approximately 60 HK.

The electric contact 16 of the connector 12 and the electric contact 26 of the connector 14 can also have the above-mentioned electrical properties and the resistance to corrosion included by the gold material because of the provision of the gold layer 42, and the good ability to make sliding contact because the gold layer 42 is thin.

The connectors 12 and 14 have a triple layer structure in which the respective plated layers 38, 40, and 42 are formed in sequence. Therefore, a pin hole 44 does not easily penetrate the plating layers 38, 40, and 42 and is much less likely to reach the metal base 36. Hence, a deterioration of the resistance to corrosion due to the pin hole 44 is effectively suppressed.

The connectors 12 and 14 in which the respective plated layers 38, 40, and 42 are formed, not only have the high electrical properties and the mechanical properties such as the resistance to corrosion and the resistance to frictional wear, but also no large force is required to insert and extract the slider due to the high ability to make sliding contact. The present invention can be utilized various kinds of electronic devices such as a personal computer, having the electric contact and/or the connector, too.

The present invention is not limited to these embodiments, but various variations and modifications may be made without departing from the scope of the present invention.

This patent application is based on Japanese priority patent application No. 2001-029822 filed on Feb. 6, 2001, the entire contents of which are hereby incorporated by reference.

What is claimed is:

1. An electric contact for making an electrical conduction by metal contact, comprising:
a metal base;
a nickel layer stacked on the metal base;
a gold layer forming an outer portion of the electric contact; and
a gold-nickel alloy layer disposed between the nickel layer and the gold layer.

2. The electric contact claimed in claim 1, wherein the gold-nickel alloy layer includes 75 to 95 mass percent gold and 5 to 25 mass percent nickel.

3. The electric contact claimed in claim 1, wherein the nickel layer has a thickness of 0.5 to 5 μm, the gold-nickel alloy layer has a thickness of 0.1 to 2 μm, and the gold layer has a thickness of 0.03 to 0.3 μm.

4. The electric contact claimed in claim 1, wherein the nickel layer, the gold-nickel alloy layer and the gold layer are formed by plating.

5. A connector, comprising:
an electric contact for making an electrical conduction by metal contact,
the electric contact comprising:
a metal base;
a nickel layer stacked on the metal base;
a gold layer forming an outer portion of the electric contact; and
a gold-nickel alloy layer disposed between the nickel layer and the gold layer.

6. The connector as claimed in claim 5, wherein the gold-nickel alloy layer includes 75 to 95 mass percent gold and 5 to 25 mass percent nickel.

7. The connector as claimed in claim 5, wherein the nickel layer has a thickness of 0.5 to 5 μm, the gold-nickel alloy layer has a thickness of 0.1 to 2 μm, and the gold layer has a thickness of 0.03 to 0.3 μm.

8. The connector as claimed in claim 5, wherein the nickel layer, the gold-nickel alloy layer and the gold layer are formed by plating.

9. An electronic device, comprising:
an electric contact for making an electrical conduction by metal contact,
the electric contact comprising:
a metal base;
a nickel layer stacked on the metal base;
a gold layer forming an outer portion of the electric contact; and
a gold-nickel alloy layer disposed between the nickel layer and the gold layer.

10. The electronic device as claimed in claim 9, wherein the gold-nickel alloy layer includes 75 to 95 mass percent gold and 5 to 25 mass percent nickel.

11. The electronic device as claimed in claim 9, wherein the nickel layer has a thickness of 0.5 to 5 μm, the gold-nickel alloy layer has a thickness of 0.1 to 2 μm, and the gold layer has a thickness of 0.03 to 0.3 μm.

12. The electronic device as claimed in claim 9, wherein the nickel layer, the gold-nickel alloy layer and the gold layer are formed by plating.
